(19) United States
(12) Patent Application Publication
(10) Pub. No.: US 2011/0209957 A1
(43) Pub. Date: Sep. 1, 2011

(54) SHOCK ABSORBER

(76) Inventor: Masahiro ASHIBA, Naka-gun (JP)

(21) Appl. No.: 13/032,892

(22) Filed: Feb. 23, 2011

(30) Foreign Application Priority Data
Feb. 26, 2010 (JP) 42511/2010

(51) Int. Cl. F16F 9/34

(52) U.S. Cl. 188/322.15; 188/322.13

(57) ABSTRACT

A piston coupled with a piston rod is inserted in a cylinder sealingly containing operating fluid. A substantially circular outer seat, an inner seat, disk support portions, an intermediate seat are provided on the lower end surface of the piston. The disk support portions are disposed between the outer seat and the inner seat. The intermediate seat is disposed between the disk support portions and the outer seat. The protruding height of the disk support portion is shorter than the protruding height of the outer seat, and equal to or taller than the protruding height of the inner seat. The protruding height of the intermediate seat is shorter than the protruding height of the outer seat, and equal to or taller than the protruding height of the disk support portions. A disk valve, which is constituted by a large-diameter disk, a first intermediate-diameter disk, a second intermediate-diameter disk, and a small-diameter disk, is seated on the outer seat, the inner seat, disk support portions, and the intermediate seat. Then, the disk valve 17 is clamped to the inner seat. When the disk valve is opened, the outer circumferential side of the large-diameter disk is deflected around the first intermediate-diameter disk, and then deflected around the second intermediate-diameter disk, and finally deflected around the small-diameter disk. Therefore, it is possible to increase the flow passage area through multiple steps to change the damping force characteristic through multiple steps.

### BACKGROUND OF THE INVENTION

The present invention relates to a shock absorber functioning by utilizing a hydraulic pressure.

Generally, a cylindrical hydraulic shock absorber mounted on a suspension apparatus of a vehicle such as a motor vehicle includes a cylinder sealingly containing an operating fluid, a piston slidably inserted in the cylinder, a piston rod coupled to the piston, and a damping force generation mechanism constituted by, for example, an orifice and a disk valve provided at the piston portion. The damping force generation mechanism controls a flow of the operating fluid caused by a sliding movement of the piston in the cylinder according to an extension/compression stroke of the piston rod by utilizing the orifice and the disk valve, thereby generating a damping force.

When the piston speed is in the low piston speed range, the damping force generation mechanism generates, by the orifice, a damping force of the orifice characteristic approximately proportional to the square of the piston speed. When the piston speed is in the high piston speed range, the disk valve is deflected to be opened, whereby the damping force generation mechanism generates a damping force of the valve characteristic approximately proportional to the piston speed. In conventional ones of this kind of shock absorber, the damping force characteristic can be set according to the area of the orifice for the damping force when the piston speed is in the low piston speed range, according to the deflection rigidity of the disk valve after the disk valve is opened for the damping force when the piston speed is in the intermediate piston speed range after the disk valve is opened, and according to the flow passage area after the disk valve is opened for the damping force when the piston speed is in the high piston speed range.

Japanese Utility Model Public Disclosure No. 02-136831 discloses a hydraulic shock absorber in which a disk valve is seated on double annular seats, i.e., an inner seat and an outer seat formed on the end surface of a piston in a protruding manner, a passage extending through the piston is opened at the inner circumferential side relative to the inner annular seat, and a cutout is formed at the inner annular seat. In this hydraulic shock absorber, when the piston speed is in the low piston speed range, the disk valve is lifted from the outer annular seat, and a damping force is generated due to the flow passage area of the cutout formed at the inner annular seat. When the piston speed is increased, the disk valve is further lifted to be moved away from the inner seat to cause an increase the flow passage area, thereby generating a damping force accordingly. Due to this configuration, the hydraulic shock absorber disclosed in Japanese Utility Model Public Disclosure No. 02-136831 enables the damping force characteristic to vary through multiple steps.

In this way, for shock absorbers, there are demands for a technology enabling generation of a desired damping force characteristic by improving flexibility of setting a damping force characteristic, such as generation of a damping force varying through multiple steps by appropriately combining an orifice and a disk valve.

### SUMMARY OF THE INVENTION

An object of the present invention is to provide a shock absorber enabling the damping force characteristic thereof to vary through multiple steps, thereby to improve flexibility of setting the damping force characteristic.

To achieve the above-mentioned objects and other objects, a shock absorber according to the present invention includes a cylinder sealingly containing operating fluid, a piston slidably inserted in the cylinder so as to divide an interior of the cylinder into two chambers, a piston rod coupled to the piston and extending to the outside of the cylinder, a passage for a flow of the operating fluid caused by a sliding movement of the piston, and a damping force generation mechanism disposed at a part of the passage and configured to generate a damping force by the flow of the operating fluid. The damping force generation mechanism includes a valve main body including the passage extending therethrough, a substantially circular outer seat provided at the valve main body in a protruding manner so as to surround an opening of the passage, an inner seat provided at an inner side relative to the outer seat in a protruding manner, the inner seat having a protruding height shorter than a protruding height of the outer seat, a disk support portion provided between the outer seat and the inner seat in a protruding manner, the disk support portion having a protruding height shorter than the protruding height of the outer seat and equal to or taller than the protruding height of the inner seat, a substantially circular intermediate seat provided between the outer seat and the disk support portion in a protruding manner so as to surround the opening of the passage, the intermediate seat having a protruding height shorter than the protruding height of the outer seat and equal to or taller than the protruding height of the disk support portion, a cutout formed at the intermediate seat, a first disk clamped to the inner seat and configured to be seated on the outer seat and the intermediate seat while being in abutment with the disk support portion, a second disk disposed on the first disk, the second disk having a diameter smaller than a diameter of the outer seat and larger than a diameter of the intermediate seat, and a third disk disposed on the second disk, the third disk having a diameter smaller than the diameter of the intermediate seat.

### BRIEF DESCRIPTION OF THE DRAWINGS

FIG. 1 is an enlarged vertical cross-sectional view illustrating a piston portion which is a main part of a shock absorber according to an embodiment of the present invention.

FIG. 2 is a bottom view of the piston of the shock absorber shown in FIG. 1.

FIG. 3 is a vertical cross-sectional view of the shock absorber shown in FIG. 1.

FIG. 4 is an enlarged vertical cross-sectional view illustrating a disk support portion of the piston of the shock absorber shown in FIG. 1.

FIG. 5 is a graph illustrating a damping force characteristic of the shock absorber shown in FIG. 1.

### DETAILED DESCRIPTION OF THE INVENTION

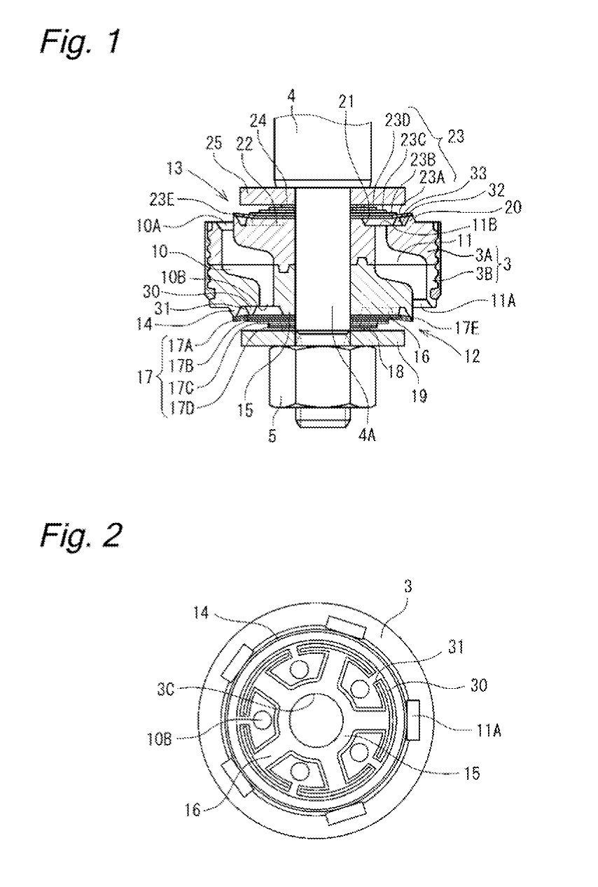

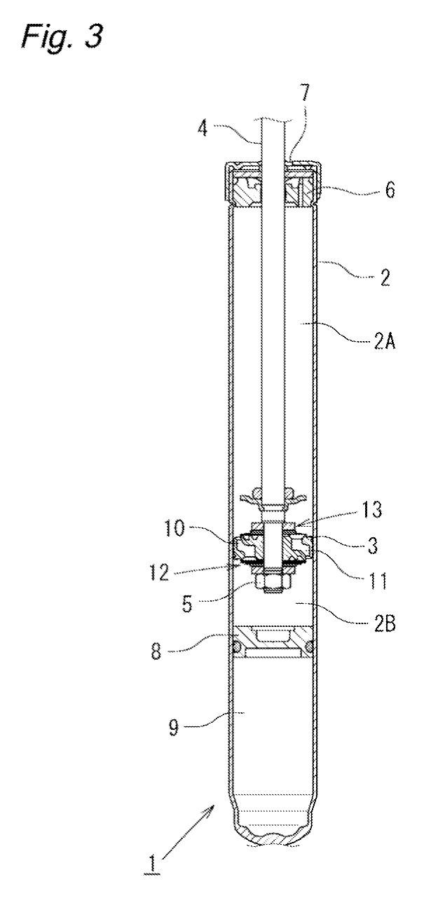

Hereinafter, an embodiment of the present invention will be described in detail with reference to the accompanying drawings. FIG. 3 illustrates an overall configuration of a shock absorber according to the present embodiment. FIG. 1 is an enlarged view of a piston portion which is a main part of the shock absorber. As shown in FIG. 3, the shock absorber 1 according to the present embodiment is a single cylinder type hydraulic shock absorber configured to be mounted on a suspension apparatus of a motor vehicle. The shock absorber 1 includes a piston 3 slidably disposed in a cylinder 2 sealingly containing hydraulic fluid as an operating fluid. The piston 3 serves as the valve main body in the present invention. A piston rod 4 extends to the outside through a seal means including a rod guide 6 and an oil seal 7 disposed at the end of the cylinder 2. One end of the piston rod 4 is coupled with a vehicle body outside the cylinder 2. On the other hand, the other end of the piston rod 4 is coupled with the piston 3 by a nut 5 within the cylinder 2. The interior of the cylinder 2 is divided into two chambers, a cylinder upper chamber 2A and a cylinder lower chamber 2B by a piston 3. A free piston 8 is slidably disposed at the bottom side of the cylinder 2 so as to define a gas chamber 9, thereby compensating a change in the volume of the cylinder upper and lower chambers 2A and 2B according to an extension/compression stroke of the piston rod 4 with the aid of compression/expansion of high-pressure gas sealingly contained in the gas chamber 9.

As shown in FIG. 1, the piston 3 has a divided structure axially divided into a plurality of pieces, and especially, divided into two pieces in the present embodiment. One of the pieces of the divided piston 3 is referred to as a piston half piece 3A, and the other is referred to as a piston half piece 3B. The piston 3 is formed by integrally joining the piston half pieces 3A and 3B, and includes extension-side passages 10 and compression-side passages 11 axially extending through the piston 3 for establishing communication between the cylinder upper lower chambers 2A and 2B. The extension-side passages 10 include a plurality of openings 10A which open at the outer circumferential portion on the upper end surface of the piston 3. In the present embodiment, the openings 10A each have a rectangular shape substantially similar to openings 11A shown in FIG. 2 which will be described later. Five openings 10A are disposed generally equiangularly along the circumferential direction. The extension-side passages 10 further include a plurality of openings 10B at the lower end surface of the piston 3. The openings 10B open at the portion radially nearer to the center, relative to the openings 10A and openings 11A of the compression-side passages 11 which will be described later. As shown in FIG. 2, in the present embodiment, the openings 10B each have a circular shape, and five openings 10B are disposed generally equiangularly along the circumferential direction.

On the other hand, the compression-side passages 11 include a plurality of openings 11A which open at the outer circumferential portion on the lower end surface of the piston 3. As shown in FIG. 2, in the present embodiment, the openings 11A each have a rectangular shape, and five openings 11A are disposed generally equiangularly along the circumferential direction. The compression-side passages 11 further include a plurality of openings 11B at the upper end surface of the piston 3. The openings 11B open at the portion radially nearer to the center, relative to the openings 11A and openings 10A of the extension-side passages 10. In the present embodiment, similarly to the openings 10B shown in FIG. 2, the openings 11B each have a circular shape, and five openings 11B are disposed generally equiangularly along the circumferential direction. The openings 10A and 11A may have a circular arc shape.

An extension-side damping force generation mechanism 12 and a compression-side damping force generation mechanism 13 are disposed at the upper and lower ends of the piston 3 for generating a damping force by controlling a flow of the hydraulic fluid caused in the extension-side passages 10 and the compression-side passages 11 by a sliding movement of the piston 3 within the cylinder 2. The piston 3 as the valve main body and the extension-side and compressions-side damping force generation mechanisms 12 and 13 adjust the flow passage area of the hydraulic fluid to control a flow of the hydraulic fluid, thereby generating a damping force.

The extension-side damping force generation mechanism 12 will be described with reference to FIGS. 1 and 2. A substantially circular outer seat 14 is provided at the lower end surface of the piston 3 in a protruding manner downwardly as viewed in FIG. 1, so as to surround the openings 10B of the extension-side passages 10 while being adjacent to the inner circumferential sides of the openings 11A of the compression-side passages 11. The term “substantially circular” is used to refer to a circular shape or an almost circular shape enabling a disk valve 17, which will be described later, to be seated on the outer seat 14 over the whole circumference of the outer seat 14 while the disk valve 17 is in a clamped state. Examples of shape expressed by this term include an oval shape having a small eccentricity. A substantially circular inner seat 15 concentric with the outer seat 14 is provided at the inner circumferential side relative to the openings 10B of the extension-side passages 10 in a protruding manner downwardly as viewed in FIG. 1. The inner seat 15 is formed around a central opening 3C of the piston 3 which receives an insertion of a small-diameter portion 4A at the tip of the piston rod 4. Further, a disk support portion 16 is formed between the outer seat 14 and the inner seat 15 in a protruding manner downwardly as viewed in FIG. 1. The protruding heights of the outer seat 14, the inner seat 15, and the disk support portion 16 are arranged in such a manner that the outer seat 14 is taller than the disk support portion 16, and the inner seat 15 is equal to or shorter than the protruding height of the disk support portion 16.

In the present embodiment, a plurality of disk support portions 16 are substantially equiangularly disposed between the openings 10B of the extension-side passages 10 in a radially extending manner. Therefore, the number of the disk support portions 16 is five so as to be equal to the number of the openings 10B. The inner circumferential portions of the disk support portions 16 are formed so as to be integrally connected to the inner seat 15. The disk support portions 16, each having a substantially constant width, extend to reach the radially outer side of the piston 3 relative to the plurality of openings 10B.

A substantially circular intermediate seat 30 is provided in a protruding manner downwardly as viewed in FIG. 1 between the disk support portions 16 and the outer seat 14 in the radial direction of the piston 3 so that the intermediate seat 30 surrounds the five openings 10B of the extension-side passages 10. The protruding height of the intermediate seat 30 is shorter than the protruding height of the outer seat 14, and equal to or taller than the protruding height of the disk support portions 16. In the present embodiment, the intermediate seat 30 is formed so as to be integrally connected to the radially outer ends of the radially extending disk support portions 16.

The intermediate seat 30 includes cutouts 31 so that communication is established between an annular chamber defined between the outer seat 14 and the intermediate seat 30, and the openings 10B of the extension-side passages 10 through the cutouts 31 with a predetermined flow passage area maintained, when the disk valve 17, which will be described later, is seated on the intermediate seat 30. In the present embodiment, five cutouts 31 are formed along the circumferential direction, similarly to the openings 10B of the extension-side passages 10. The position, number, size, and shape of the cutout 31 may be appropriately set according to a desired flow passage area.

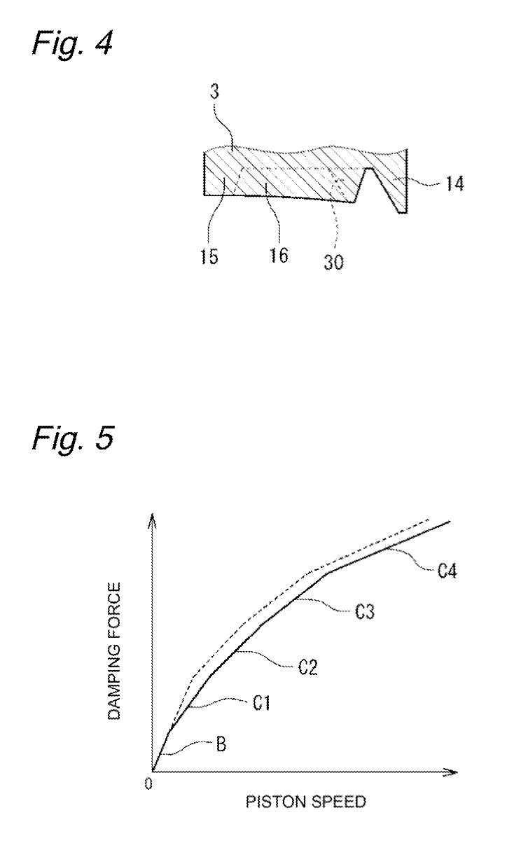

As shown in FIG. 4, the protruding height of the disk support portion 16 is arranged in such a tapering manner that the disk support portion 16 has the same height as the inner seat 15 at the inner circumferential side connected to the inner seat 15, is getting taller toward the outer circumferential side, and has the same height as the intermediate seat 30 at the outer circumferential end connected to the intermediate seat 30. The disk support portion 16 tapers, defining a concave surface in the embodiment shown in FIG. 4, but the disk support portion 16 may taper, defining a conical surface with a linear line in cross-section. Alternatively, the disk support portion 16 may taper, defining a convex surface. In this case, however, the outer circumferential side of the disk valve 17, which will be described later, is more easily liftable from (difficult to abut against) the convex surface, and therefore the effect is reduced compared to the conical surface.

The disk valve 17 constituted by a plurality of stacked circular disks is in abutment with and seated on the outer seat 14, the inner seat 15, the disk support portions 16, and the intermediate seat 30. The inner circumferential portion of the disk valve 17 is pressed against and clamped to the inner seat 15 with the aid of clamping by the nut 5 through a retainer 18 and a spacer 19. In this state, the disk valve 17 is pressed against the outer seat 14, the inner seat 15, the disk support portions 16, and the intermediate seat 30 with an initial deflection generated due to the difference among the protruding heights at the abutment portion with the outer seat 14, the inner seat 15, the disk support portions 16, and the intermediate seat 30.

The disk valve 17 is constituted by a large-diameter disk 17A (first disk), a first intermediate-diameter disk 17B (second disk), a second intermediate-diameter disk 17C (third disk), and a small-diameter disk 17D (fourth disk). The large-diameter disk 17A is in abutment with and seated on the outer seat 14, the inner seat 15, the disk support portions 16, and the intermediate seat 30. The first intermediate-diameter disk 17B is disposed on the large-diameter disk 17A, and has a diameter smaller than the diameter of the outer seat 14 and larger than the diameter of the intermediate seat 30. The second intermediate-diameter disk 17C is disposed on the first intermediate-diameter disk 17B, and has a smaller diameter than the diameter of the intermediate seat 30. The small-diameter disk 17D is disposed on the second intermediate-diameter disk 17C, and has a smaller diameter than the diameter of the second intermediate-diameter disk 17C. The retainer 18 has a smaller diameter than the diameter of the small-diameter disk 17D. A cutout is formed at the outer circumferential portion of the large-diameter disk 17A seated on the outer seat 14. The cutout constitutes an orifice 17E providing constant communication between the extension-side passage 10 and the cylinder lower chamber 2B. The flow passage area of the orifice 17E is smaller than the flow passage area of the cutout 31. The cutout constituting the orifice 17E may be formed at the outer seat 14 instead of the large-diameter disk 17A by, for example, the coning method.

The compression-side damping force generation mechanism 13 is configured in the following manner, similarly to the above-mentioned extension-side damping force generation mechanism 12. A substantially circular outer seat 20, an inner seat 21, radially extending disk support portions 22, and an intermediate seat 32 are formed on the upper end surface of the piston 3 in a protruding manner. A disk valve 23, which is constituted by a large-diameter disk 23A (first disk), a first intermediate-diameter disk 23B (second disk), a second intermediate-diameter disk 23C (third disk), and a small-diameter disk 23D (fourth disk), is in abutment with and seated on these outer seat 20, the inner seat 21, the disk support portions 22, and the intermediate seat 32. The first intermediate-diameter disk 23B has a diameter smaller than the diameter of the large-diameter disk 23A and larger than the diameter of the intermediate seat 32. The second intermediate-diameter disk 23C is disposed on the first intermediate-diameter disk 23B, and has a smaller diameter than the diameter of the intermediate seat 32. The small-diameter disk 23D has a smaller diameter than the diameter of the second intermediate-diameter disk 23C. The inner circumferential portion of the disk valve 23 is pressed against and clamped to the inner seat 21 through a retainer 24 and a spacer 25 by fastening of the nut 5. The retainer 24 has a smaller diameter than the diameter of the small-diameter disk 23D. Cutouts 33 are formed at the intermediate seat 32. The disk valve 23 is pressed against the outer seat 20, the inner seat 21, the disk support portions 22, and the intermediate seat 32 with an initial deflection generated due to the difference among the protruding heights of the outer seat 20, the inner seat 21, the disk support portions 20, and the intermediate seat 32 (the outer seat>the intermediate seat≧the disk support portions≧the inner seat). A cutout is formed at the outer circumferential portion of the large-diameter disk 23A seated on the outer seat 20. The cutout constitutes an orifice 23E providing constant communication between the compression-side passage 11 and the cylinder upper chamber 2A. The flow passage area of the orifice 23E is smaller than the flow passage area of the cutout 33. The cutout constituting the orifice 23E may be formed at the outer seat 20 instead of the large-diameter disk 23A by, for example, the coning method.

The present embodiment configured as mentioned above functions as follows. During an extension stroke of the piston rod 4, a sliding movement of the piston 3 in the cylinder 2 causes the hydraulic fluid in the cylinder upper chamber 2A to be pressurized and sent to the cylinder lower chamber 2B through mainly the extension-side passages 10. At this time, a damping force is generated by the extension-side damping force generation mechanism 12.

Then, when the speed of the piston 3 is in the low piston speed range, a damping force of the orifice characteristic is generated by the orifice 17E of the disk valve 17. At this time, the pressure of the pressurized hydraulic fluid in the cylinder upper chamber 2A does not yet reach a valve opening pressure for the disk valve 17, and thereby the disk valve 17 is not opened. Referring to FIG. 5, the curved line B indicates the damping force characteristic by the orifice 17E.

When the piston speed is increased to enter the intermediate piston speed range, the pressure of the pressurized hydraulic fluid in the cylinder upper chamber 2A reaches the valve opening pressure for the disk valve 17, and thereby the disk valve 17 is opened and a damping force of the valve characteristic is generated. At this time, the large-diameter disk 17A is pressed against the disk support portions 16 having the protruding height gradually increasing from the inner circumferential side to the outer circumferential side, the intermediate seat 30, and the outer seat 14 having the tallest protruding height, with an initial deflection generated at the disk valve 17, by the spring forces of the first and second intermediate-diameter disks 17B and 17C, and the small-diameter disk 17D, in addition to the spring force of the large-diameter disk 17A. Therefore, the outer circumferential side of the large-diameter disk 17A is more easily deflectable than the inner circumferential side of the large-diameter disk 17A.

Therefore, first, the outer circumferential side of the large-diameter disk 17A is deflected around the outer circumferential portion of the first intermediate-diameter disk 17B to be moved away from the outer seat 14 while the large-diameter disk 17A is seated on the intermediate seat 30, as the pressure in the cylinder upper chamber 2A is increased. In this state, the hydraulic fluid flows through the cutouts 31 at the intermediate seat 30, and receives a flow resistance according to the flow passage area of the cutouts 31. When the piston speed is further increased and the pressure is further increased at the inner circumferential side of the intermediate seat 30, the large-diameter disk 17A is further deflected around the outer circumferential portion of the second intermediate-diameter 17C together with the first intermediate-diameter disk 17B to be moved away from the intermediate seat 30. Then, the large-diameter disk 17A is further deflected around the outer circumferential portion of the small-diameter disk 17D together with the first and second intermediate-diameter disks 17B and 17C. Then, the large-diameter disk 17A is further deflected around the retainer 18 together with the first and second intermediate-diameter disks 17B and 17C and the small-diameter disk 17D, and then finally is opened after undergoing multi-stepped valve open states.

As a result, the flow passage area from the extension-side passages 10 to the cylinder lower chamber 2B is increased through multiple steps, and it is possible to obtain the damping force characteristic as indicated by the solid line in FIG. 5. In FIG. 5, the curved line B indicates the orifice characteristic. The curved lines C1, C2, C3, and C4 indicate the valve characteristics when the large-diameter disk 17A is deflected around the first intermediate-diameter disk 17B, around the second intermediate-diameter disk 17C, around the small-diameter disk 17D, and around the retainer 18, respectively. In this way, it is possible to achieve smooth transition from the orifice characteristic (curved line B) to the valve characteristic (curved lines C1 to C4), thereby providing a stabilized damping force. The broken line in FIG. 5 indicates the damping force characteristic of the above-mentioned embodiment without the intermediate seat 30, and reveals that the provision of the intermediate seat 30 facilitates smooth and clear transition from the orifice characteristic to the valve characteristic.

On the other hand, during a compression stroke of the piston rod 4, a sliding movement of the piston 3 in the cylinder 2 causes the hydraulic fluid in the cylinder lower chamber 2B to be pressurized and sent to the cylinder upper chamber 2A through mainly the compression-side passages 11. At this time, a damping force is generated by the compression-side damping force generation mechanism 13.

Then, similarly to the extension stroke, when the piston speed is in the low piston speed range, a damping force of the orifice characteristic is generated due to the orifice 23E of the disk valve 23. When the piston speed enters the intermediate piston speed range and the pressure of the hydraulic fluid in the cylinder lower chamber 2B reaches the valve opening pressure for the disk valve 23, the disk valve 23 is deflected to be opened, and thereby a damping force of the valve characteristic is generated.

At this time, the flow passage area from the compression-side passages 11 to the cylinder upper chamber 2A is increased through multiple steps due to the difference among the protruding heights of the outer seat 20, the inner seat 21, the intermediate seat 32, and the disk support portions 22, and the disk valve 23 constituted by stacking the large-diameter disk 23A, the first intermediate-diameter disk 23B, the second intermediate-diameter disk 23C, and the small-diameter disk 23D. Therefore, similarly to the above-mentioned extension stroke, it is possible to achieve smooth and clear transition from the orifice characteristic to the valve characteristic, thereby providing a stabilized damping force.

In the present embodiment, the substantially circular shape of the outer seats 14 and 20 enables the cutouts at the large-diameter disks 17A and 23A, which define the orifices 17E and 23E, to be formed at any position in the circumferential direction. Therefore, the large-diameter disks 17A and 23A are not required to be aligned circumferentially when they are attached to the piston 3, resulting in improved assemblability.

Further, in the present embodiment, the tapering shape of the disk support portions (the concaved surface inclined toward the radially outer side) enables a connection of the inner seat, the disk support portions, the intermediate seat, and the outer seat without a step generated among them. Therefore, the present embodiment may prevent occurrence of the problem in that a leak of the fluid from a gap between a step and the disk valve makes it difficult to obtain a damping force of a desired characteristic.

Further, in the present embodiment, the disk valve 23 is pressed against the outer seat 20, the inner seat 21, the disk support portions 22, and the intermediate seat 32 with an initial deflection generated due to the difference among the protruding heights of the outer seat 20, the inner seat 21, the disk support portions 22, and the intermediate seat 32 (the outer seat>the intermediate seat≧the disk support portions≧the inner seat). A set load is applied to the disk valve due to this initial deflection, which eliminates the need of stacking many disk valves to apply a set load to the disk valve. As a result, the number of required parts can be reduced, leading to improved manufacturability and assemblability.

In the above-mentioned embodiment, the disk valves 17 and 23 are constituted by the four disks having different diameters, the large-diameter disks 17A and 23A, the first intermediate-diameter disks 17B and 23B, the second intermediate-diameter disks 17C and 23C, and the small-diameter disks 17D and 23D. However, the present invention is not limited thereto. The disk valves may be constituted by any combination of three or more disks including a first disk (the large-diameter disks 17A and 23A), a second disk (the first intermediate-diameter disks 17B and 23B), and a third disk (the second intermediate-diameter disks 17C and 23C) used in the present invention so that the deflection amount at the time of a valve open can be changed through multiple steps due to the difference in deflection rigidity between the inner circumferential side and the outer circumferential side.

Further, in the above-mentioned embodiment, the disk support portions 16 and 22 are radially arranged, and extend between the inner seats 15 and 21 and the intermediate seats 30 and 32. However, the disk support portions 16 and 22 may be arranged in a different manner as long as the following conditions are satisfied: the disk support portions 16 and 22 are located between the intermediate seats 30 and 32 and the inner seats 15 and 21; the protruding heights of the disk support portions 16 and 22 are equal to or shorter than the protruding heights of the intermediate seats 30, 32 and equal to or taller than the protruding heights of the inner seats 15, 21; and the disk support portions 16 and 22 can support the disk valves 17 and 23 in such a manner that the disk valves 17 and 23 can be opened in a stepwise manner as mentioned above. For example, the disk support portions 16 and 22 may be divided and arranged as a plurality of pieces. Alternatively, the disk support portions 16 and 22 may be shaped in such a manner that the widths thereof radially taper toward the outer circumferential side or the inner circumferential side. Further, the pressure receiving areas of the disk valves 17 and 23 to the passages 10 and 11 can be adjusted by the areas of the abutment portions between the disk support portions 16 and 22 and the disk valves 17 and 23.

The above-mentioned embodiment has been described based on the single cylinder type shock absorber including the gas chamber 9 defined by the free piston 8 in the cylinder 2, and using the piston 3 as the valve main body. However, the present invention is not limited thereto. The present invention may be embodied by a double cylinder type shock absorber including a base valve at the bottom of the cylinder so as to connect a cylinder chamber to a reservoir through the base valve, and using the base valve as the valve main body. Alternatively, the present invention may be embodied by a shock absorber including a damping force generation mechanism disposed outside a cylinder, and a valve main body disposed at the damping force generation mechanism disposed outside the cylinder.

Further, the above-mentioned embodiment has been described based on the hydraulic shock absorber capable of generating a damping force by controlling a flow of the hydraulic fluid. However, the present invention is not limited thereto. The present invention may be applied to a shock absorber capable of generating a damping force by controlling a flow of another fluid such as gas, although it is desirable that the operating fluid is embodied by operating liquid in consideration of the stability of the damping force characteristic. Further, in the above-mentioned embodiment, the protruding portions such as the outer seat, the inner seat, the disk support portions, and the intermediate seat are integrally formed by, for example, die molding or cutting. However, they maybe formed, for example, by appropriately stacking washers.

According to the shock absorber of the above-mentioned embodiment, it is possible to change the damping force characteristic through multiple steps to improve flexibility of setting the damping force characteristic.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority to Japanese Patent Application No. 2010-042511 filed on Feb. 26, 2010. The entire disclosure of Japanese Patent Application No. 2010-042511 filed on Feb. 26, 2010 including specification, claims, drawings and summary is incorporated herein by reference in its entirety.

What is claimed is:

1. A shock absorber comprising:
a cylinder sealingly containing operating fluid;
a piston slidably inserted in the cylinder so as to divide an interior of the cylinder into two chambers;
a piston rod coupled to the piston and extending to the outside of the cylinder;
a passage for a flow of the operating fluid caused by a sliding movement of the piston; and
a damping force generation mechanism disposed at a part of the passage and configured to generate a damping force by the flow of the operating fluid,
the damping force generation mechanism comprising
a valve main body including the passage extending therethrough,
a substantially circular outer seat provided at the valve main body in a protruding manner so as to surround an opening of the passage,
an inner seat provided at an inner side relative to the outer seat in a protruding manner, the inner seat having a protruding height shorter than a protruding height of the outer seat,
a disk support portion provided between the outer seat and the inner seat in a protruding manner, the disk support portion having a protruding height shorter than the protruding height of the outer seat and equal to or taller than the protruding height of the inner seat,
a substantially circular intermediate seat provided between the outer seat and the disk support portion in a protruding manner so as to surround the opening of the passage, the intermediate seat having a protruding height shorter than the protruding height of the outer seat and equal to or taller than the protruding height of the disk support portion,
a cutout formed at the intermediate seat,
a first disk clamped to the inner seat and configured to be seated on the outer seat and the intermediate seat while being in abutment with the disk support portion,
a second disk disposed on the first disk, the second disk having a diameter smaller than a diameter of the outer seat and larger than a diameter of the intermediate seat, and
a third disk disposed on the second disk, the third disk having a diameter smaller than the diameter of the intermediate seat.

2. The shock absorber according to claim 1, wherein a fixed orifice is provided at the outer seat or the first disk, and a flow passage area of the cutout is larger than a flow passage area of the fixed orifice.

3. The shock absorber according to claim 1, wherein the intermediate seat, the disk support portion, and the inner seat are integrally connected.

4. The shock absorber according to claim 2, wherein the intermediate seat, the disk support portion, and the inner seat are integrally connected.

5. The shock absorber according to claim 1, wherein the disk support portion is shaped in such a manner that the protruding height of the disk support portion is gradually increased from the inner seat side to the outer seat side.

6. The shock absorber according to claim 2, wherein the disk support portion is shaped in such a manner that the protruding height of the disk support portion is gradually increased from the inner seat side to the outer seat side.

7. The shock absorber according to claim 3, wherein the disk support portion is shaped in such a manner that the protruding height of the disk support portion is gradually increased from the inner seat side to the outer seat side.

8. The shock absorber according to claim 5, wherein the disk support portion has a concaved curved surface.

9. The shock absorber according to claim 1, wherein the third disk is clamped to the inner seat, and a fourth disk having a smaller diameter than the diameter of the third disk is disposed on the third disk.

10. The shock absorber according to claim 2, wherein the third disk is clamped to the inner seat, and a fourth disk having a smaller diameter than the diameter of the third disk is disposed on the third disk.

11. The shock absorber according to claim 9, wherein a retainer having a smaller diameter than the diameter of the fourth disk is disposed on the fourth disk.

12. The shock absorber according to claim 10, wherein a retainer having a smaller diameter than the diameter of the fourth disk is disposed on the fourth disk.

13. The shock absorber according to claim 1, wherein a retainer having a smaller diameter than the diameter of the third disk is disposed on the third disk.

14. The shock absorber according to claim 1, wherein the disk support portion comprises a plurality of radially arranged disk support portions.

15. The shock absorber according to claim 1, wherein the outer seat, the inner seat, the disk support portion, and the intermediate seat are formed integrally with the valve main body by die molding.

16. The shock absorber according to claim 1, wherein the valve main body serves as the piston.

17. The shock absorber according to claim 15, wherein the valve main body serves as the piston.
